(19) United States
(12) Patent Application Publication
(10) Pub. No.: US 2004/0095362 A1
(43) Pub. Date: May 20, 2004

(54) Bicycle computer allowing user to input desired data

(75) Inventor: Eiji Koumoto, Nishinomiya-shi (JP)

Correspondence Address: OLSON & HIERL, LTD., 36th Floor, 20 North Wacker Drive, Chicago, IL, 60606, US

(73) Assignee: Cateye Co., Ltd.

(21) Appl. No.: 10/663,116

(22) Filed: Sep. 16, 2003

Related U.S. Application Data
(63) Continuation of application No. 09/645,855, filed on Aug. 24, 2000.

(30) Foreign Application Priority Data
Aug. 25, 1999 (JP) 11-238282

(51) Int. Cl. G09G 5/00

(52) U.S. Cl. 345/636

(57) ABSTRACT

Run data of a bicycle and personal information of a user are input in a bicycle computer. A display part of the bicycle computer has upper and lower lines, which can be set to desired display sizes. A screen unknown to the user is prepared in the display part of the bicycle computer. When the user enters his name and the data of birth in the bicycle computer, the display part displays a message “happy birthday to you” on the corresponding day.

### RELATED APPLICATION

This application is a continuation of Ser. No. 09/645,855 filed Aug. 24, 2000 in the name of Eiji Koumoto for a Bicycle Computer Allowing User to Input Desired Data, which application claimed priority under 35 USC 119 based on Japanese Application No. 11-238282 filed Aug. 25, 1999.

### BACKGROUND OF THE INVENTION

1. Field of the Invention

The present invention relates to a bicycle computer, and more particularly, it relates to a bicycle computer customizable for a user.

2. Description of the Prior Art

In general, a bicycle computer attached to a handlebar etc. of a bicycle so that run information or the like can be input and displayed is put on the market.

In the conventional bicycle computer, the current mileage, the current speed, the cumulative mileage etc. of the bicycle are input for displaying the current mileage, the cumulative mileage or the maximum speed during riding in response to a user's request.

In the conventional bicycle computer, however, a display part displaying data or the like is formed by a plurality of segments and hence the display contents are disadvantageously standardized.

Further, the display contents are predetermined and the user cannot input desired data or the like. Therefore, the user is not much attached to the computer itself.

### SUMMARY OF THE INVENTION

Accordingly, an object of the present invention is to provide a bicycle computer capable of amusing a user.

Another object of the present invention to provide a bicycle computer customizable by the user.

Still another object of the present invention is to provide a bicycle computer capable of providing unexpected pleasure to the user.

A further object of the present invention is to provide a display method for a bicycle computer capable of amusing the user.

A bicycle computer according to the present invention includes a run information input part for inputting run information of a bicycle, a display for displaying the input run information and a selector for selecting a display mode on the display.

The run information input in the bicycle computer can be displayed in a desired display mode, whereby a bicycle computer capable of amusing a user can be provided. The display, displaying mileage or the like, for example, in digital data, can display yearly, monthly or weekly mileage as a graph.

Preferably, the bicycle computer further includes an input unit for inputting personal information of the user. Since the personal information of the user can be input, the contents or the mode of display can be diversified. Consequently, a bicycle computer capable of further amusing the user can be provided. The date of birth, the name etc. of the user can be input as personal data.

Preferably, the selector for selecting the display mode can select a display size for displaying the run information. The user can select the size of displayed characters or numerals in response to the display contents, so that information is displayed in a size responsive to the user's choice for the display contents. When the display is formed by upper and lower lines, for example, the size of characters or numerals displayed on the upper and lower lines respectively can be arbitrarily selected.

More preferably, the display is formed by a plurality of dot displays. When the display is formed by a plurality of dots, arbitrary display is enabled. For example, part of information can be digitally displayed while displaying the remaining part as a graph.

More preferably, the bicycle computer further includes a selector for selecting run information displayed on the display from the run information. The user can select the information displayed on the display part, whereby a customizable bicycle computer can be provided.

More preferably, the user is not previously informed of contents displayed on the display.

The bicycle computer prepares a hidden screen unknown to the user and makes an unexpected display for the user. The user is surprised to see the display, looks forward to a next unexpected display, and takes to the bicycle computer. When personal data of the user are input, the bicycle computer displays a message “Mr.(or Ms.) ◯◯, happy birthday to you!” on the user's birthday, for example.

According to another aspect of the present invention, a bicycle computer includes a run information input part for inputting run information of a bicycle, an input unit for inputting personal information of a user, a display for displaying information based on the input run information or personal information and a selector for selecting a display mode on the display.

According to still another aspect of the present invention, a method of making a display on a display part of a bicycle computer includes steps of inputting run information of a bicycle, inputting personal information of a user, displaying information based on the input run information or personal information, selecting a display mode on the display and displaying the information in the selected mode.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A, 1B and 1C are a front elevational view, a left side elevational view and a rear elevational view of a bicycle computer 10 according to the present invention;

FIGS. 2A to 2F illustrate exemplary displays on a display part in relation to respective buttons;

FIG. 3 illustrates exemplary displays on the display part;

FIG. 4 illustrates a procedure of operations performed by a user purchasing the bicycle computer;

FIG. 5 illustrates a procedure for replacing a battery;

FIG. 6 illustrates a procedure for formatting;

FIGS. 7 and 8 illustrate a setup procedure and screen transition on the display part;

FIG. 9 illustrates a customize setup procedure and screen transition of display contents thereof;

FIG. 10 illustrates a display of all selectable functions;

FIG. 11 illustrates another customize setup procedure and screen transition of the display contents thereof;

FIG. 12 illustrates screen transition in the case of employing a menu function (data menu);

FIG. 13 illustrates screen transition in the case of employing another menu function (set menu);

FIG. 14 illustrates screen transition in formatting;

FIG. 15 illustrates screen transition in mode navigation;

FIGS. 16A and 16B illustrate exemplary displays of other functions;

FIG. 17 illustrates states of transition of hidden screens; and

FIG. 18 illustrates the contents of hidden screens related to mileage.

FIG. 19 is a block diagram of the bicycle computer.

### DESCRIPTION OF THE PREFERRED EMBODIMENTS

An embodiment of the present invention is now described with reference to the drawings.

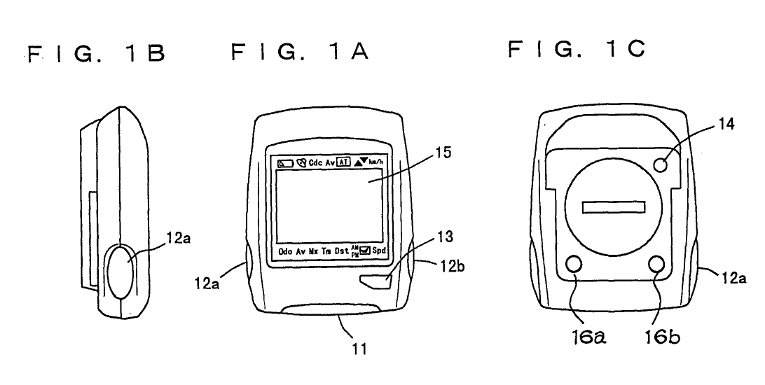

Referring to FIGS. 1A to 1C, a bicycle computer 10 includes a start/stop button (hereinafter referred to also as select buttons when deciding display contents 11, mode buttons (hereinafter referred to also as select button when selecting display contents) 12a and 12b, a menu button 13, a restart button 14 and a display part 15.

Contact points 16a and 16b are provided at the rear of the bicycle computer 10 to a receiving running data of the bicycle to which the computer 10 is attached.

The start/stop button 11 is a pushbutton switch for setting start/stop of measurement of mileage or a speed, for example, and settles various types of settings.

The mode buttons 12a and 12b for selecting a mode and the like are provided on both sides of the bicycle computer 10 as shown in FIG. 1A. The mode buttons 12a and 12b are employed for switching measuring functions in measurement and selecting each setting in setting. The mode (select) button 12a and 12b may be provided not on both sides of the bicycle computer 10 but on upper and lower positions of one side. In the following description, the mode button 12a and 12b are basically provided on both sides of the bicycle computer 10. When selecting either one of upper and lower parts of a display with either one of the mode buttons 12a and 12b provided on both sides, the mode button 12a is pressed for selecting the upper display part or the mode button 12b is pressed for selecting the lower part, for example. In other words, the mode button 12a and 12b can be used as UP and DOWN buttons respectively for selecting displayed characters or numerals so that the selection can be settled with the enter button.

The menu button 13 is employed for setting each menu function. The restart button 14 is a pushbutton switch employed for resetting hardware.

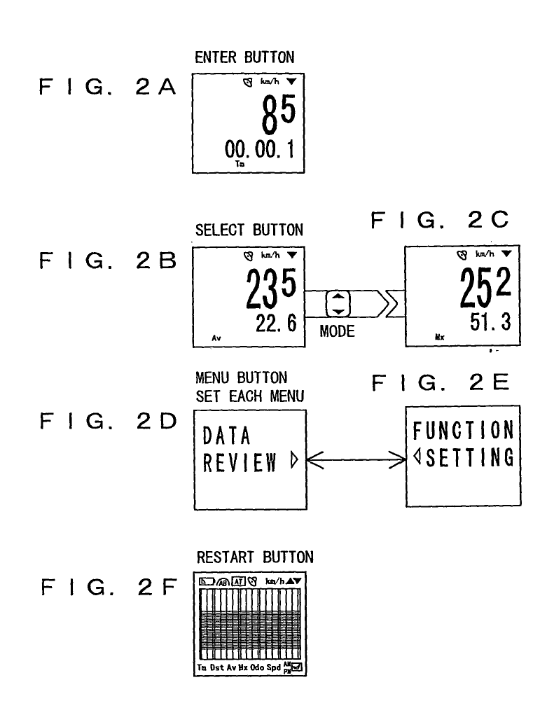

FIGS. 2A to 2F illustrate exemplary display states on the display part 15 shown in FIG. 1A. A conventional display part makes a display with the so-called 7 segments, and hence the display contents thereof are standardized. According to the present invention, the display part 15, formed by a dot display, can make an arbitrary display.

Referring to FIG. 2A, the enter button 11 is pressed. The display part 15 displays a speed and mileage on upper and lower lines thereof in different sizes. Referring to FIG. 2B, the select button 12a and 12b are pressed. When the select button 12a or 12b are pressed, the display part 15 sequentially displays selected functions (FIG. 2C).

Referring to FIG. 2D, the menu button 13 is pressed. When the menu button 13 is pressed, the display part 15 displays two folders including a data recording verification chart 2D and a setting change chart 2E. Referring to each of FIGS. 2D and 2E, a white triangle flickers to urge the user of the bicycle computer 10 to choose the select button 12a and 12b directed by the triangle. Such a white display flickers in all screens in common.

Referring to FIG. 2F, the restart button 14 is pressed so that th display part 15 makes no display.

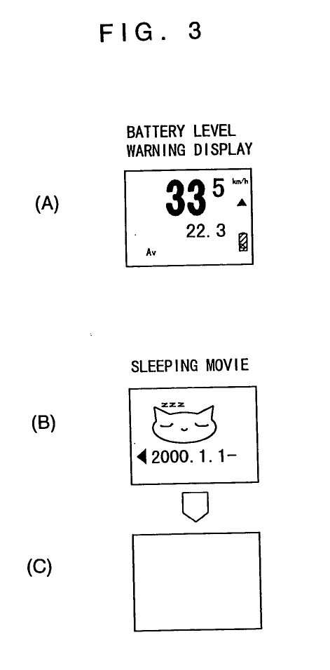

FIGS. 3(A) and 3(B) illustrate exemplary display states following selection of functions. FIG. 3(A) illustrates a warning display for the level of a battery. When the level of the battery lowers, the display part 15 displays a battery mark in addition the general display of the speed and mileage. The battery mark flickers when this state continues for several days and the level of the battery drops below a prescribed value, and the screen display entirely disappears when the level of the battery reaches zero. Hatching may express such a flickering part, as shown in FIG. 3(A).

FIG. 3(B) illustrate a display of a sleeping movie screen described below. The display part 15 displays the date and the current time on the lower line while scrolling along arrow. When displaying the sleeping movie for 10 minutes, the display part 15 automatically enters an economy mode. In the economy mode, the display part 15 makes no display as shown in FIG. 3(C). When any button is pressed or a signal is received in this state, the display part 15 returns to a general state.

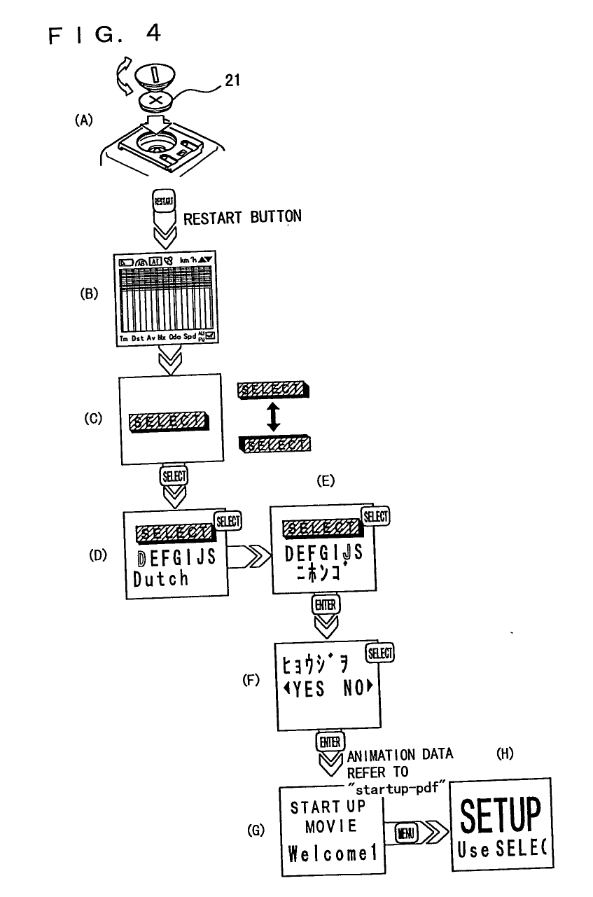

An operation procedure for the bicycle computer 10 is now described. FIGS. 4(A) to 4(H) illustrates the procedure of operations performed by the users purchasing the bicycle computer 10. Referring to FIGS. 4(A) to 4(H), the user first inserts a battery 21 in a prescribed battery compartment. When the user presses the restart button 14, the display part 15 displays a full-flashing screen (FIG. 4(B)). Thereafter the display part 15 displays a language selection screen (FIG. 4(C)). The user selects a desired language with the select button 12a and 12b (FIGS. 4(D) and 4(E)) and presses the enter button 1 1 for the currently displayed language so that the display part 15 displays a screen for verifying selection of the language (FIG. 4(F)). The selected language is settled when the user presses the enter button 11 while “YES” flickers. The display part 15 returns to the preceding screen when the user presses the enter button 11 while “NO” flickers.

In the display on the lowermost stage of FIG. 4(D) and the katakana displays shown in FIGS. 4(E) and 4(F), the characters repeatedly scroll from right to left.

Then, the display part 15 displays a startup screen (FIG. 4(G)). On this startup screen, the display part 15 displays a message “You can readily set up this cycle computer for selecting each mode as a customize function and entering your personal information. The first time you turn on this cycle computer, press menu (MENU) button 13.”, for example. In the display of the message, the characters also repeatedly scroll from right to left on the screen.

Then, a setup start screen (FIG. 4(H)) automatically appears. The user selects each setting with the set buttons 12a and 12b and decides the setting with the enter button 11. When the user simultaneously presses the select buttons 12a and 12b, the display part 15 returns to the preceding screen. The user can go to the next screen by pressing the enter button 11.

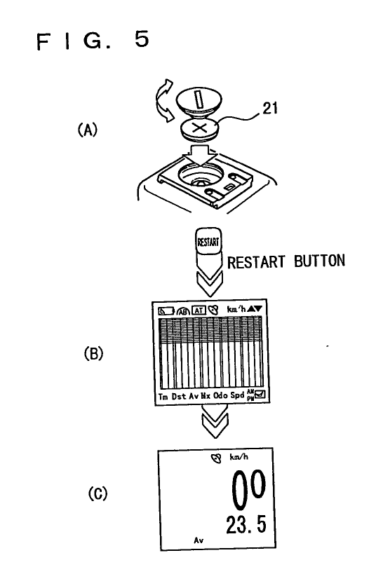

FIGS. 5(A) to 5(C) illustrates a procedure for renewing the battery 21. The user inserts a new battery 21 in the battery compartment after the removing the old one (FIG. 5(A)). Then, the user presses the restart button 14 so that the display part 15 displays the full-flashing screen (FIG. 5(B)). Then, the display part 15 returns to a screen before battery renewal (FIG. 5(C)). When the user first presses the menu button 13 after renewing the battery 21, a time setting screen appears. This is because the bicycle computer 10 stops counting time during the battery renewal.

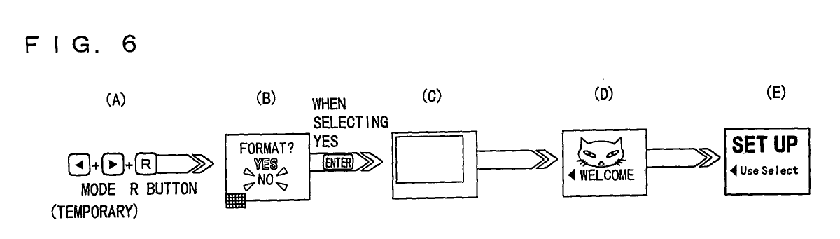

FIGS. 6(A) and 6(E) illustrate a procedure of formatting. When the user simultaneously presses the two select buttons 12a and 12b and the restart button 14 (FIG. 6(A)), the display part 15 asks the user whether or not to format the bicycle computer 10 (FIG. 6(B)). In order to format the bicycle computer 10, the user presses the select button 12a and selects “YES”. Then, the display part 15 displays the full-flashing screen (FIG. 6(C)). Thereafter the display part 15 displays a language selection screen. When the user selects the language, the display part 15 displays a startup screen (FIG. 6(D)), and then displays a setup start screen (FIG. 6(E)). Small triangles enclosing “NO” in FIG. 6(B) indicates that the enclosed data flickers. This also applies to the following description.

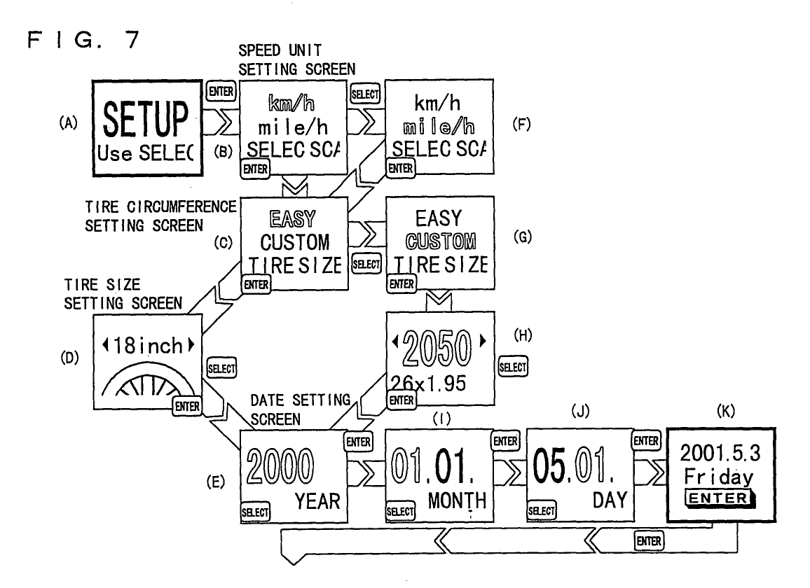

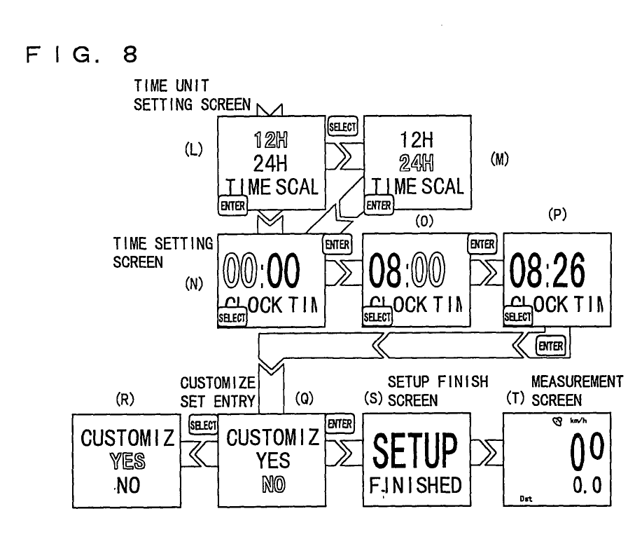

A set-up method is now described. FIGS. 7(A) to 7(K) and 8(L) to 8(T) illustrate transition states of the display part 15 in the setup operation. When the user presses the enter button 11 on the setup screen (FIG. 7(A)), the display part 15 displays a speed unit setting screen (FIG. 7(B)). When the user presses the enter button 11, the display part 15 displays a tire circumference setting screen for enabling the user to enter a tire size (FIG. 7(C)). In characters EASY and CUSTOM displayed on this screen, the characters EASY flicker. When allowing EASY, the user presses the enter button 11 for selecting an EASY mode. At this time, the user can set the tire size in the range of 14 to 28 inches by pressing the select button 12a or 12b. When the display part 15 displays a desired size in inches, the user presses the enter button 11 for setting the tire size (FIG. 7(D)). On the screen shown in (FIG. 7(D)), the display part 15 automatically displays the tire size in inches.

When the user presses the enter button 11 again in this state, the display part 15 displays a date setting screen for enabling the user to set the date (FIG. 7(E)).

When the user presses the select buttons 12a and 12b on the speed unit setting screen shown in FIG. 7(B), the mode is set and the display part 15 repeats the display (FIG. 7(F)). When the user presses the enter button 11 in this state, the display part 15 displays the screen shown in FIG. 7(C).

When the user simultaneously presses the select buttons 12a and 12b on the display screen shown in FIG. 7(C), the display part 15 returns to the preceding screen (FIGS. 7(B) or 7F)). The user can select a CUSTOM mode by pressing the select button 12a (FIG. 7(G)). When the user presses the enter button 11 in the state shown in FIG. 7(G), the display part 15 displays the tire size in millimeters while displaying the corresponding size on the lower stage (FIG. 7(H)). The user can select a desired size in millimeters by pressing the select button 12a or 12b. When the user presses the enter button 11 in this state, the display part 15 displays the screen shown in FIG. 7(E).

On each of the screens shown in FIGS. 7(A) to 7(G), characters appearing on the lowermost stage repeatedly scroll from right to left.

On the date setting screen shown in FIG. 7(E), the user can first select the year. The user can select the year by pressing the select button 12a or 12b. Then the user can select the month by pressing the enter button 11 after selecting the year, and can set the day by pressing the enter button 11 after setting the month (FIG. 7(J)). When the user presses the enter button 11 in this state, the display part 15 displays the set date and the day of the week (FIG. 7(K)). The user can set the time unit by pressing the enter button 11 in this state (FIGS. 8(L) and 8(M)).

“12 H” flickers in FIG. 8(L), and “24 H” flickers in FIG. 8(M) respectively. When the user presses the enter button 11 on either screen, the display part 15 displays a time setting screen (FIG. 8(N)). The user presses the select buttons 12a and 12b in this state for switching the display screen and setting the hour and minutes (FIGS. 8(O) and 8(P)). Also on these screens, the display of the hour and minutes flicker. When the user presses the enter button 11 on the screen shown in FIG. 8(P), the display part 15 displays a customize set entry screen (FIG. 8(Q)). “NO” already flickers as a default on this screen, and hence the display part 15 displays a customize setting screen when the user presses the select button 12a in this state (FIG. 8(R)). Through this customization, the user can select functions and enter personal information for forming a specific computer of his own.

When the user presses the enter button 11 on the customize setting screen (FIG. 8(Q)), the display part 15 makes transition in order of a setup finish screen (FIG. 8(S)) and a measurement screen (FIG. 8(T)).

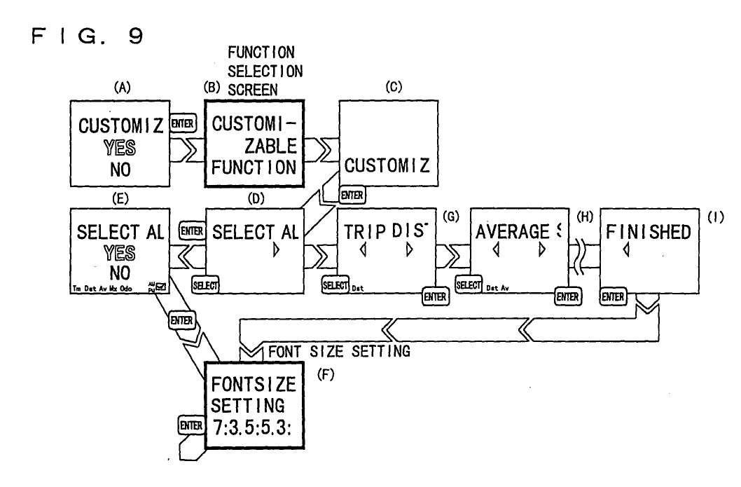

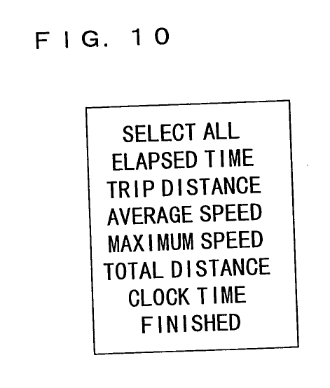

FIGS. 9(A) to 9(F) illustrate a procedure for a customized setup operation on the bicycle computer 10. Referring to FIGS. 9(A) to 9(F), the user presses the enter button 11 while “YES” flickers (FIG. 8(A)) so that the display part 15 makes transition to a screen for selecting customizable functions (FIG. 9(B)). The user can select necessary functions on this screen. When the user presses the enter button 11 in this state, the display part 15 displays a specific function selection screen and asks the user whether or not to select all functions (hereinafter referred to as “select all”) (FIG. 9(D)). The display part 15 displays “SELECT ALL”, “ELAPSED TIME”, “TRIP DISTANCE”, “AVERAGE SPEED”, “MAXIMUM SPEED”, “TOTAL DISTANCE”, “CLOCK TIME” and “FINISHED”, as shown in FIG. 10. When the user presses the enter button 11 in the state of “SELECT ALL”, the display part 15 displays an inquiry screen as to “YES” or “NO” (FIG. 9(E)), and the display of “YES” flickers.

When the user presses the enter button 11, “SELECT ALL” is settled.

In each of the customize displays shown in FIGS. 9(A) and 9(C) and the displays on the upper stage of FIGS. 9(D), 9(E), 9(G) and 9(H), characters repeatedly scroll from right to left on the screen.

When the user presses the enter button 11 in this state, the display part 15 displays a font size setting screen (FIG. 9(F)). The user sets a desired font size on this screen.

When the user presses the right select button 12b on the “SELECT ALL” display shown in FIG. 9(D), the display part 15 displays a screen for selecting individual functions. On this screen, the display part 15 asks the user whether or not to set mileage (FIG. 9(G)) and an average speed (FIG. 9(H)).

The user selects desired functions by pressing the select button 12a and 12b in these states, and then presses the enter button 11 after selecting the functions. The user successively selects necessary functions in the aforementioned manner, and the display part 15 asks the user whether or not to finish the selection after completing the displays (FIG. 9(I)). When the user presses the enter button 11 in this state, the display part 15 displays the aforementioned font size setting screen shown in FIG. 9(F)).

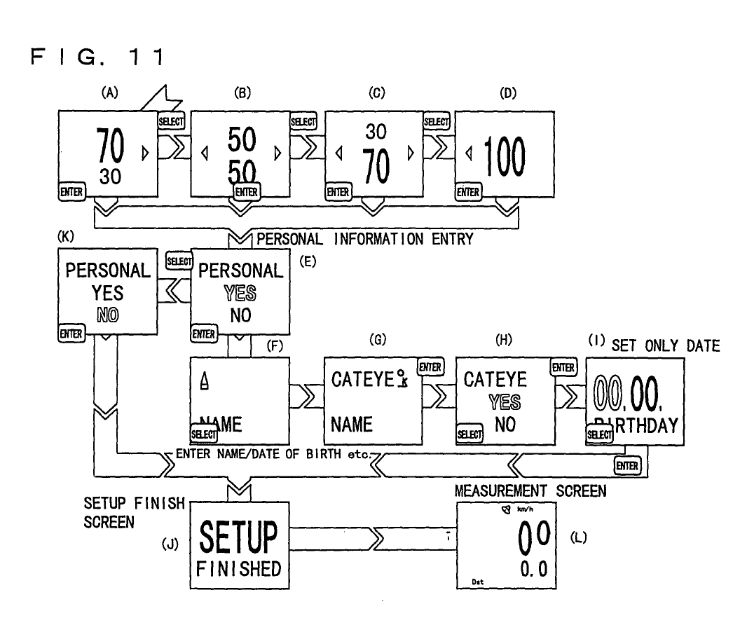

FIGS. 11(A) to 11(L) illustrate a procedure for setting the font size and inputting personal information. When setting the font size, the user can set the size ratio of the characters appearing on the upper line to those appearing on the lower line. When the user presses the enter button 11 on the screen shown in FIG. 9(F), the display part 15 displays a screen for selecting whether or not to set the upper and lower lines in the ratio 70:30 (FIG. 11(A)). When accepting this display state, the user presses the enter button 11.

In order to change the size ratio, the user presses the select button 12b on the screen shown in FIG. 11(A). Then, the display part 15 displays a screen as to whether or not to set the upper and lower lines in the ratio 50:50 (FIG. 11(B)). When accepting this state, the user presses the enter button 11. In order to select another ratio, the user presses the select button 12b. Then, the display part 15 displays a screen as to whether or not to set the upper and lower lines in the ratio 30:70 (FIG. 11(C)). When accepting this state, the user presses the enter button 11. In order to select still another ratio, the user presses the select button 12b. Then, the display part 15 displays a single-line display as shown in FIG. 11(D). When accepting this state, the user presses the enter button 11.

When the user presses the enter button 11 on any of the aforementioned screens shown in FIGS. 11(A) to 11(D), the display part 15 displays a personal data entry screen (FIG. 11(E)). In order to enter personal information, the user presses the enter button 11 while “YES” flickers. Then, the display part 15 shifts to a personal information entry screen (FIG. 11(F)). On this screen, the first alphabetic character “A” flickers. The user selects a desired alphabet by pressing the select button 12a or 12b and settles the selected alphabet by pressing the enter button 11. The user thereafter repeats this operation to enter his name (“CATEYE” in the figures) (FIGS. 11(E) to 11(G). When the user settles the data in FIG. 11(H) by pressing the enter button 11 while “YES” flickers, the display screen 15 shifts to a birthday screen (FIG. 11(I)). The user enters numerals similarly to the characters. “00” first appears on the screen and flickers. The user selects numerals by pressing the select buttons 12a and 12b and settles the selected numerals by pressing the select buttons 12a and 12b and settles the selected numerals by pressing the enter button 11. When the user sets a desired date by pressing the mode button 12a and 12b, the display screen 15 shifts to a setup finish screen (FIG. 11(J)). When not entering personal information in FIG. 11(E), the user selects “NO” by pressing the mode button 12a or 12b (FIG. 11(K) so that the display screen 15 shifts to a setup finish screen shown in FIG. 11(J). After a lapse of about three seconds, the display part 15 automatically shifts to a measurement screen (FIG. 11(L)).

The menu function (data menu) are now described. When employing the menu function, the use can verify data on a last ride or stored data with the menu button 13. The bicycle computer 1 has two menus including a setting menu and a data menu.

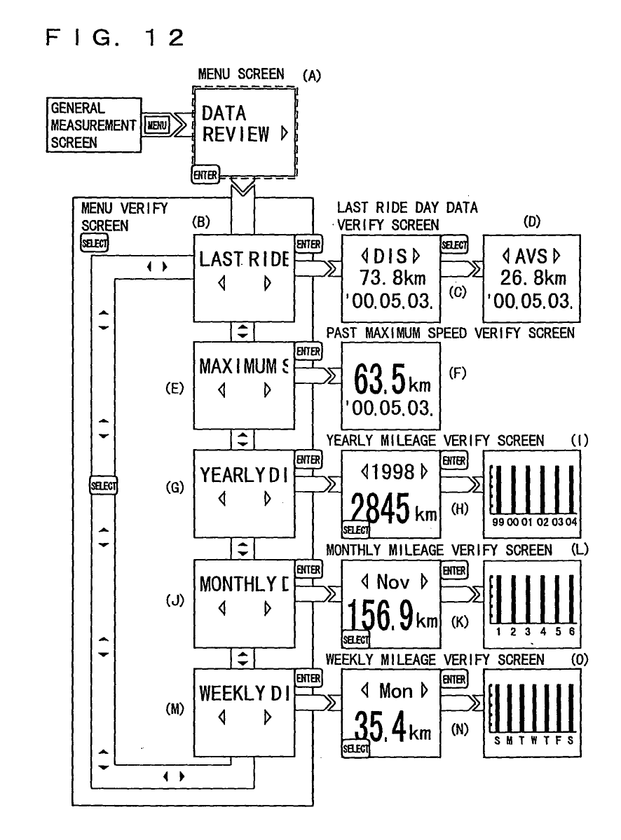

FIGS. 12(A) and 12(O) illustrate transition of menu screens related to one of the menu functions.

When the user presses the menu button 13 on the general measurement screen, the display part 15 displays a menu screen (FIG. 12(A)). When the user presses the enter button 11, the display part 15 displays a last ride screen (FIG. 12(B)) so that the user selects a desired screen by pressing the select buttons 12a and 12b. When the user presses the enter button 11 in the state shown in FIG. 12(B), the display part 15 displays a last ride data verify screen (FIG. 12(C)). On this screen, the display part 15 displays the mileage and the date of the last ride on the upper and lower lines respectively. When the user presses the select button 12b in this state, the display part 15 displays the average speed (FIG. 12(D)).

When the user selects a maximum speed display screen by pressing the select buttons 12a and 12b in the state shown in FIG. 12(B) and then presses the enter button 11, the display part 15 displays a verify screen for the maximum speed in the past (FIG. 12(F)).

When the user selects a yearly mileage display screen and presses the enter button 11, the display part 15 displays a yearly mileage verify screen (FIG. 12(H)). When the user presses the enter button 11 in this state, the display part 15 graphs out past mileage (FIG. 12(I)). Referring to FIG. 12(I), the display part 15 displays the mileage for six years from left to right with reference to the year exhibiting the maximum value.

The display part 15 displays a monthly mileage verify screen (FIG. 12(K)) when the user presses the enter button 11 on the month mileage screen (FIG. 12(J)), and the display part 15 graphs out the monthly mileage when the user presses the enter button 11 in this state (FIG. 12(L)).

In order to verify weekly mileage, the user presses the enter button 11 on a weekly mileage display screen (FIG. 12(M)). Then, the display part 15 displays a weekly mileage display screen (FIG. 12(M)). The display part 15 graph out the weekly mileage when the user presses the enter button 11 in this state (FIG. 12(O).

On each of the screens shown in FIGS. 12(B), 12(E), 12(G), 12(J) and 12(M), characters appearing on the upper line repeatedly scrolls from right to left.

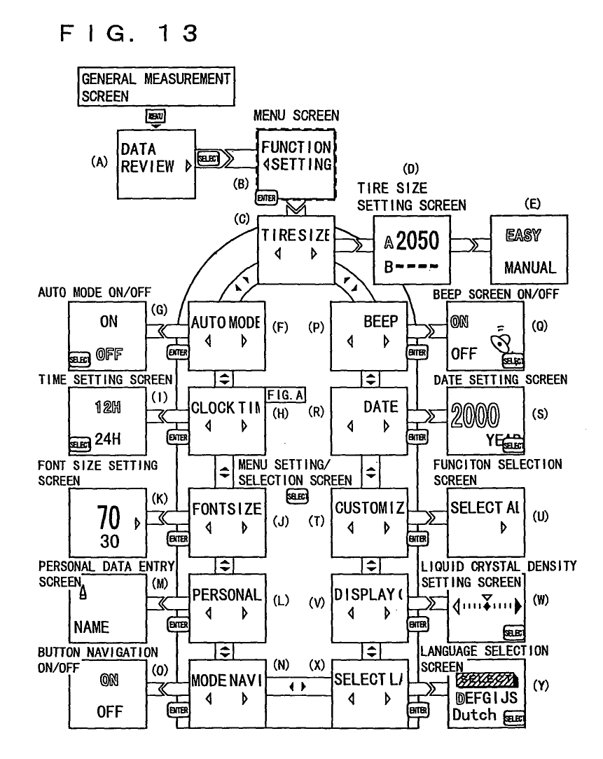

Another menu function (setting menu) is now described with reference to FIGS. 13(A) to 13(Y). In this menu function, the user performs a set operation other than the setup (during measurement/when starting riding etc.) or changes the functions with the menu button 13. The menus are roughly classified into the setting menu and the data menu.

The user presses the menu button 13 on the general measurement screen, for example, to go to the menu function (FIG. 13(A)). When the user presses the select buttons 12a and 12b in this state, the display part 15 displays a menu function setting screen (FIG. 13(B)). When the user presses the enter button 11, the display part 15 displays a tire size setting screen, for example (FIG. 13(C)). When the user presses the enter button 11 in this state, the display part 15 makes transition to further tire size setting screens (FIGS. 13(D) and 13(E)).

The user can select an auto mode setting screen (FIG. 13(F)) or an operation screen (FIG. 13(P)) by pressing the select buttons 12a and 12b on the screen shown in FIG. 13(C). When the user presses the enter button 11, the display part 15 displays an auto mode on/off setting screen or a beep on/off setting screen (FIG. 13(G)).

On the menu screen, the user can select a time setting screen (FIG. 13(H)), a font size setting screen (FIG. 13(J)), a personal data entry screen (FIG. 13(L)), a mode navigation setting screen (FIG. 13(N)), a date setting screen (FIG. 13(R)), a function setting screen (FIG. 13(T)), a liquid crystal contrast setting screen (FIG. 13(V)) or a language selection screen (FIG. 13(X)) in addition to the above.

The user presses the enter button 11 on each setting screen, so that the contrast part 15 displays each setting screen (FIGS. 13(I), 13(M), 13(O), 13(S), 13(U), 13(W) or 13(Y)).

When the user decides each setting and presses the enter button 11, the display part 15 returns to the menu function setting screen (FIG. 13(B)).

On each of the screens shown in FIGS. 13(C), 13(F), 13(H), 13(J), 13(N), 13(P), 13(R), 13(T), 13(V), 13(X) and 13(U), characters appearing on the upper line repeatedly scroll from right to left.

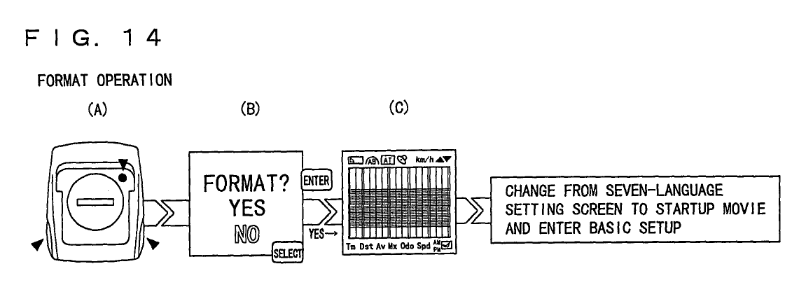

Operations necessary for measurement and convenient functions are now described. FIGS. 14(A) to 14(C) are diagrams for illustrating formatting. In order to format the bicycle computer 10, the user simultaneously presses the select buttons 12a and 12b and the restart button 14 (FIG. 14(A)). Then, the display part 15 displays a verify screen as to whether or not to format the bicycle computer 10 (FIG. 14(B)). The user can format the bicycle computer 10 by selecting “YES” with the select buttons 12a and 12b and pressing the enter button 11. The display part 15 first displays the full-flashing screen (FIG. 14(C)). the full-flashing screen changes to a seven-language setting screen and then to a startup movie, and the bicycle computer 10 enters a basic setup mode.

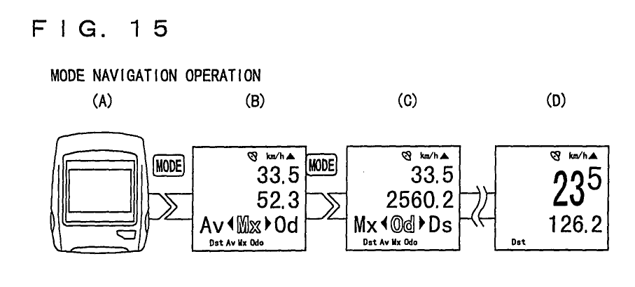

Mode navigation is now described with reference to FIGS. 15(A) to 15(D). In order to perform mode navigation, the user presses either select button 12a or 12b once on the measurement screen (FIG. 15(A)). Then, the display part 15 displays the current mode on the lower line for about one second (FIG. 15(B)). When the user presses the select button 12a or 12b again in this state, the display part 15 displays a next or preceding mode (FIG. 15(C)). After a lapse of about one second, the display part 15 returns to the original screen (FIG. 15(D)).

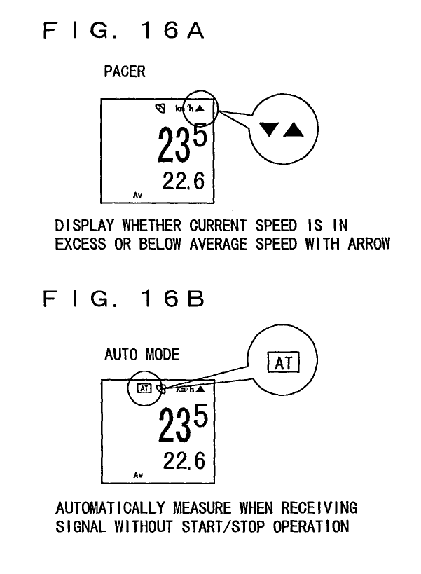

FIG. 16A shows a display screen of a pacer function. On this screen, the display part 15 displays whether the current speed is in excess or below the average speed with arrow.

FIG. 16B shows an auto mode screen. The bicycle computer automatically starts measurement without any start/stop operation when receiving a signal.

Hidden screens are now described. The user is not previously informed of the hidden screens displayed on the display part 15.

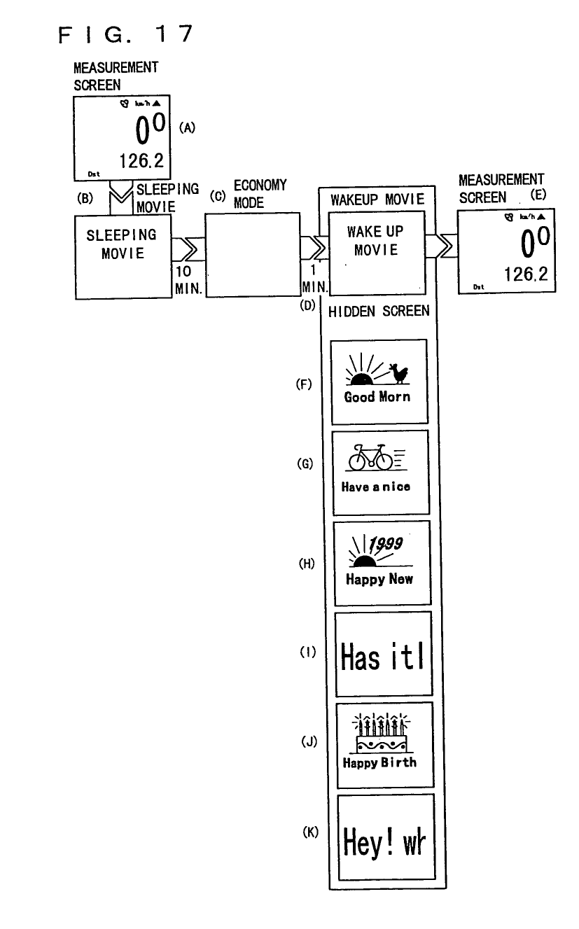

FIGS. 17(A) to 17(K) show states of transition of screens not corresponding to the hidden screens. When receiving no signal for 10 minutes, for example, on the general measurement screen (FIG. 17(A)), the display part 15 automatically shifts to a sleeping movie from the measurement screen (FIG. 17(B)). When receiving no signal in this state for one minute, the display part 15 makes transition from the sleeping move to an economy mode, to make no display (FIG. 17(C)).

The display part 15 displays a wakeup movie (FIG. 17(D)) when the user presses any button or the bicycle computer 10 receives a signal, and shifts to the general measurement screen when receiving a signal again (FIG. 17(E)).

FIGS. 17(F) to 17(K) illustrate states of transition of screens corresponding to the hidden screens. When the user presses any button or the bicycle computer 10 receives a signal, the display part 15 displays a hidden screen corresponding to the day for about 2 or 3 seconds so that a message transversely scrolls on the screen once.

Referring to FIG. 17(F), the display part 15 displays marks of a cock and the morning sun with a message “Good Morning”. Thereafter the display part 15 shifts to the general measurement screen (FIG. 17(E)).

The display part 15 displays this screen when the user rides on the bicycle first between 5 a.m. and 10 a.m., for example.

When the user rides on the bicycle first between 10:01 a.m. and 4:59 p.m., the display part 15 displays a message “Have a nice ride”, as shown in FIG. 17(G).

When the user rides on the bicycle first between January 1 and January 31, the display part 15 displays a message “Happy New Year” (FIG. 17(H)).

When the user rides on the bicycle first after one year from formatting the bicycle computer 10 and setting the time, the display part 15 displays a message “Has it been another year already” (FIG. 17(I)).

When the user enters his name and the date of birth and rides on the bicycle first on his birthday, the display part 15 displays a message “Happy Birthday to ◯◯” (FIG. 17(I)).

When the user does not ride on the bicycle for a week, the display part 15 displays a message “Hey, where have you been?” (FIG. 17(K).

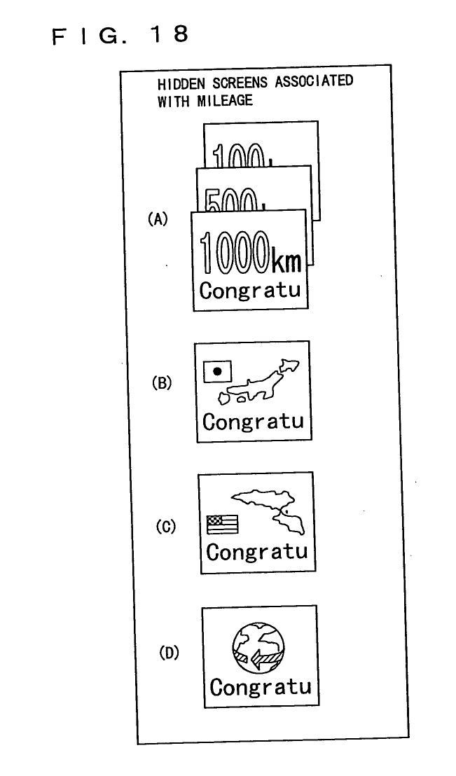

In addition to the above, displays shown in FIGS. 18(A) to 18(D) are conceivable as hidden screens associated with mileage.

When the cumulative mileage reaches 100 km, 500 km or 1000 km, the display part 15 displays a screen shown in FIG. 18(A). the numeral shown on this screen flickers.

When the cumulative mileage reaches the distance down through Japan, the display part 15 displays a screen shown in FIG. 18(B).

When the cumulative mileage reaches the distance down through the American continent, the display part 15 displays a screen shown in FIG. 18(C).

When the cumulative mileage reaches the distance around the earth, the display part 15 displays a screen shown in FIG. 18(D). On each of the screens shown in FIGS. 18(A) to 18(D), characters appearing on the lowermost line repeatedly scroll from right to left.

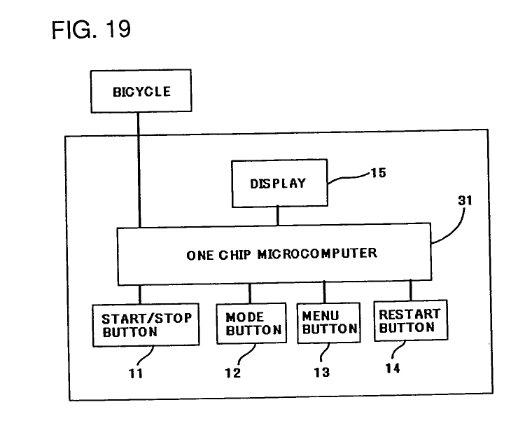

A block diagram of bicycle computer 10 is shown in FIG. 19. With reference to FIG. 19, the bicycle computer 10 has one chip microcomputer 31 controlling all the elements of the bicycle computer 10, display 15, with memory and buttons 11-14. Data and signals from the bicycle and buttons 11-14 are transmitted to one chip microcomputer 31 to be processed an then stored in memory and/or to be displayed in display 15. The hidden screens are stored in the memory.

While the sizes of characters and numerals can be selected as the display contents in the aforementioned embodiment, the present invention is not restricted to this but a display or a graph can also be selected.

While characters are alphabetically displayed in the aforementioned embodiment, the present invention is not restricted to this but the display part 15 may display characters in a desired language such as Japanese or in a mixture of two or more desired languages.

While characters repeatedly scroll from right to left on the screen in parts of the displays, the present invention is not restricted to this but characters displayed on other desired parts may repeatedly scroll from right to left on the screen or may be fixedly displayed.

Although the present invention has been described and illustrated in detail, it is clearly understood that the same is by way of illustration and example only and is not to be taken by way of limitation, the spirit and scope of the present invention being limited only by the terms of the appended claims.

I claim

1. A bicycle computer comprising:
a run information input part for inputting information including run information of a bicycle;
a personal input part for inputting personal information of a user;
display means for displaying a plurality of information including said input run information and said input personal information of the user;
customization select means for selecting by the user whether or not to customize contents to be displayed on said display means;
customization item select means for selecting an item to be customized when said customization is selected; and
display mode select means for selecting a display mode for said selected item to be customized, and said display mode selecting means select a number of lines to be displayed on said display means.

2. The bicycle computer according to claim 1, wherein said display mode select means select, when said number of lines to be displayed on said display means are two including upper and lower lines, respective display sizes at said upper and lower lines.

3. The bicycle computer according to claim 1, wherein said item to be customized is said input run information.

4. The bicycle computer according to claim 1, further comprising:
means for storing said personal information of the user and said run information of the bicycle; and
means for determining if said personal information of the user or said run information of the bicycle meets a prescribed requirement; wherein
said display means display a prescribed indication when said means for determining determine that said prescribed requirement is met.

5. The bicycle computer according to claim 1, wherein said display means displays information in upper and lower lines.

6. The bicycle computer according to claim 5, including a selector for selecting the display size of said upper and lower lines.

7. The bicycle computer according to claim 1, wherein said display means includes a mode of displaying a part in a digital system and another part in an analog system.

8. The bicycle computer according to claim 1, wherein said display means includes a display of a graph system.

9. The bicycle computer according to claim 1, including a selector for selecting a display language on said display means.

10. A method of making a display on a display part of a bicycle computer, including the steps of:
inputting to the bicycle computer run information of said bicycle;
inputting to the bicycle computer personal information of a user;
displaying information on the display part based on said input run information or personal information;
selecting whether or not to customize information to be displayed on said display part;
selecting an item to be customized when customization of information is selected;
selecting a display mode for said item to be customized, and
selecting a number of lines to be displayed on said display means.
